(19) United States
(12) Patent Application Publication
(10) Pub. No.: US 2013/0203273 A1
(43) Pub. Date: Aug. 8, 2013

(54) HIGH SPEED BACKPLANE CONNECTOR

(71) Applicant: James Rathburn, Maple Grove, MN (US)

(72) Inventor: James Rathburn, Maple Grove, MN (US)

(73) Assignee: HSIO Technologies, LLC, Maple Grove, MN (US)

(21) Appl. No.: 13/575,368

(22) PCT Filed: Jan. 31, 2011
(86) PCT No.: PCT/US11/23138

§ 371 Date: Oct. 5, 2012

Related U.S. Application Data
(60) Provisional application No. 61/300,628, filed on Feb. 2, 2010.

(51) Int. Cl. H01R 12/72; H01R 43/20

(52) U.S. Cl. CPC H01R 12/721; H01R 43/20
USPC 439/67; 29/876

(57) ABSTRACT

A backplane connector including a substrate and a backplane connector set attached to the substrate. The backplane connector set includes a plurality of interconnect elements each having a conductive trace, a first contact member, and a second contact members matched to the first contact member. The first and second contact members extend beyond perimeter edges of the substrate. A plurality of conductive tie bars retain the interconnect elements in a fixed relationship prior to attachment to the substrate. Additive printing processes can be used to form the conductive traces.

### TECHNICAL FIELD

The present application relates to a high performance electrical interconnect between one printed circuit board (“PCB”) and another printed circuit board. The present disclosure improves the performance of existing backplane connector sets by leveraging alternate manufacturing techniques to reduce cost and provide an opportunity to increase interconnect density.

### BACKGROUND OF THE INVENTION

System architectures for data, communications, industrial, and instrumentation applications often include two or more printed circuit boards electrically couple with a backplane connector. Backplane connectors typically include a plurality of conductive traces each with a pair of mating male/female contacts at each end. One half of the mated pair is mounted to one PCB, and the other half of the pair is mounted to the other PCB.

The contacts can be fashioned with compliant tails that are forced into a via in the PCB. The compliant tails used for mounting along with the via required for insertion are parasitic and can disrupt signal performance or create an impedance mismatch. The contact structures can be extremely long relatively speaking due to the need to change directions for lateral to vertical or right angle interfaces, and the pitches used are relatively large due to a variety of mechanical and electrical issues.

Alternatively, a connectors is mounted to one of the circuit boards to receive the contacts on the backplane connector. Male contacts are typically blade contacts that have no meaningful compliance. Compliant beams within the female connector provide the mating action as the blade deforms the contacts. The use of an intermediate connector between the backplane connector and the PCB also has parasitic effects that can disrupt signal performance or create an impedance mismatch.

The pitches of the contacts are relatively large at 1.35 mm, 2.0 mm, and 3.0 mm. These contact families are also relatively expensive due to the large material content and relatively sophisticated design and tooling requirements. Several large connector suppliers produce connectors of this type such as Tyco, FCI, Molex, Foxconn, Amphenol, and Teradyne. These companies sell the connectors to OEMs or CEMs producing end products such as Servers, Storage Systems, Networking Switches, Routers, Telecommunications, Wireless Basestation as well as Test, Measurement, and Medical equipment.

Recent designs of this type of product are constructed with a wafer or cartridge style assembly, where a column of contacts are produced using conventional methods and then placed into a molded housing which positions the wafers in the proper location. Performance requirements today range in the 2.5 GHz to 10 GHz range, with future needs extending to 40 GHz and potentially 100 GHz. Deployment strategies appear to be multiples of 10 GHz (4×10=40 and 10×10=100) or possibly multiple of 25 GHz for 100 GHz (4×25).

There has been some effort to develop solder ball or BGA style attachment between backplane connectors and PCB's to eliminate the via requirements and ease routing constraints. The PCB's used with these solder ball style attachments are often large, with many layers and consequently very expensive compared to thinner PCB's with fewer layers.

The entire internet and communications structure networks around the world rely on these types of connectors to transmit data, and as signal speeds and power requirements evolve there is a significant opportunity to improve the interconnect architectures. As system architectures evolve, the environment these types of connectors operate in will become increasingly complex with a huge expansion in bandwidth and speed requirements. Existing products can meet today's electrical performance needs with relatively expensive connector products and sophisticated system and circuit board designs.

### BRIEF SUMMARY OF THE INVENTION

The present disclosure is directed to a high speed backplane connector (“HSBC”) that will enable next generation electrical performance. The present disclosure improves the performance of existing backplane connector sets by leveraging alternate manufacturing techniques to reduce cost and provide an opportunity to increase interconnect density. The present backplane connector is a drop in replacement for existing products, with an evolutionary road map to higher performance and increased density, while enabling an overall system cost reduction.

Conventional backplane connector products are produced by stamping and forming operations, with the contact structures inserted into a plastic housing or placed into a mold where plastic material is injected in precise locations. The present disclosure merges techniques for handling a connector set as a group, leveraging methods used in the semiconductor packaging Industry, as well as to provide electrical enhancements to meet the needs of high performance environments with a product that resembles known technologies to reduce barriers to adoption.

Semiconductor packaging products utilize what has been called a leadframe, where the interconnect elements are fashioned as a group ganged together by tie bars that allow group handling and processing. The interconnect elements forming the connectors set structure are fashioned from blank material by blanking or etching, with small tie bars connecting the group of interconnect elements until a point in the process where the tie bars are eliminated to singulated the interconnect paths. An interconnect wafer or substrate is used as a planar element to construct the circuitry for installation into a housing which locates the interconnect elements in the proper position. Essentially, the connector set can be imaged and etched or blanked with conventional tooling methods, then processed as a group until a point where they are singulated to eliminate the structural tie bars.

One embodiment is directed to a backplane connector including a substrate and a backplane connector set attached to the substrate. The backplane connector set includes a plurality of interconnect elements each having a conductive trace, a first contact member, and a second contact members matched to the first contact member. The first and second contact members extend beyond perimeter edges of the substrate. A plurality of conductive tie bars retain the interconnect elements in a fixed relationship prior to attachment to the substrate.

The first contact members can be bifurcated beams. Each beam optionally is a separate circuit path. The contact members can optionally be a plurality of conductive layers, with or without an intermediate dielectric layer. In one embodiment, a pair of opposing surfaces at distal ends of the contact members captures solder balls. One or more of a dielectric layer and a shielding layer may be laminated to at least the conductive traces. Electrical devices can be printed on the substrate and electrically coupled to at least one conductive trace.

The present disclosure is also directed to the use of additive printing processes to form the conductive traces. Additive printing technologies permit a wide variety of materials to be applied on a layer with a registration relative to the features of the previous layer. Selective addition of conductive, non-conductive, or semi-conductive materials at precise locations to create a desired effect has the major advantages in tuning impedance or adding electrical function on a given layer. Tuning performance on a layer by layer basis relative to the previous layer greatly enhances electrical performance.

One embodiment is directed to a substrate with recesses corresponding to a target circuit geometry. A conductive material is printed in at least a portion of the recesses to form a circuit geometry. At least one dielectric covering layer is printed over at least the circuit geometry.

In one embodiment, pre-formed conductive trace materials are located in the recesses. The recesses are than plated to form conductive traces with substantially rectangular cross-sectional shapes. In another embodiment, a conductive foil is pressed into at least a portion of the recesses. The conductive foil is sheared along edges of the recesses. The excess conductive foil not located in the recesses is removed and the recesses are plated to form conductive traces with substantially rectangular cross-sectional shapes.

At least one electrical device is optionally printed on the substrate and electrically coupled to at least a portion of the circuit geometry. Optical quality materials can be printed or deposited in at least a portion of the recesses to form optical circuit geometries. Alternatively, optical fibers can be located in the recesses.

A conductive plating layer is optionally applied on at least a portion of the circuit geometry. The conductive material can be sintered conductive particles or a conductive ink. In one embodiment, a compliant material is located between the substrate and at least a portion of the circuit geometry.

The resulting circuit geometry preferably has conductive traces that have substantially rectangular cross-sectional shapes, corresponding to the recesses. The use of additive printing processes permits conductive material, non-conductive material, and semi-conductive material to be located on a single layer.

The present disclosure is also directed to a first printed circuit board electrically coupled to the first contact members of the backplane connector, and a second printed circuit board electrically coupled to the second contact members. In one embodiment, the first contact members extend into vias in the first printed circuit board. The second contact members are optionally electrically coupled with blades on an intermediate connector attached to the second printed circuit board.

In another embodiment, the backplane connector includes a plurality of recesses formed in a substrate corresponding to a circuit geometry. A conductive material is deposited in at least a portion of the recesses to make conductive traces. First contact members and second contact members matched to the first contact members are electrically coupled to each conductive trace. The first and second contact members extend beyond perimeter edges of the substrate. At least one dielectric covering layer preferably extends over at least the conductive traces.

The present disclosure is also directed to a method of making a backplane connector. A backplane connector set is formed with a plurality of interconnect elements each having a conductive trace, a first contact member, and a second contact member matched to the first contact member. A plurality of conductive tie bars retain the interconnect elements in a fixed relationship prior to attachment to the substrate. The backplane connector set is attached to a substrate so that the first and second contact members extend beyond perimeter edges of the substrate. The tie bars are then removed, such as by etching.

Another method of making the present backplane connector includes forming a plurality of recesses in a substrate corresponding to target conductive traces. Conductive material is printed in at least a portion of the recesses to make conductive traces. Matched pairs of first and second contact members are attached to each conductive trace such that the first and second contact members extend beyond perimeter edges of the substrate. A dielectric covering layer is optionally printed over at least the conductive traces.

### BRIEF DESCRIPTION OF THE SEVERAL VIEWS OF THE DRAWING

FIG. 1 illustrates a backplane connector contact set in accordance with an embodiment of the present disclosure.

FIG. 2 illustrates the backplane connector set of FIG. 1 attached to a substrate in accordance with an embodiment of the present disclosure.

FIG. 3 illustrates a dielectric layer applied to the backplane connector of FIG. 2.

FIG. 4 illustrates a backplane connector assembly in accordance with an embodiment of the present disclosure.

FIG. 5 illustrates an interface between a backplane connector and a printed circuit board in accordance with an embodiment of the present disclosure.

FIGS. 6A and 6B are side and front views of contact members for a backplane connector in accordance with an embodiment of the present disclosure.

FIG. 7 is a cross-sectional view of a backplane connector in accordance with an embodiment of the present disclosure.

FIG. 8 is a cross-sectional view of an alternate backplane connector in accordance with an embodiment of the present disclosure.

FIGS. 9A and 9B are side and front views of contact members for a backplane connector in accordance with an embodiment of the present disclosure.

FIGS. 10A and 106B are side and front views of bifurcated contact members for a backplane connector in accordance with an embodiment of the present disclosure.

FIGS. 11A and 11B are side and front views of shaped contact members for a backplane connector in accordance with an embodiment of the present disclosure.

FIGS. 12A and 12B are side and front views of multi-layered contact members for a backplane connector in accordance with an embodiment of the present disclosure.

FIGS. 13A and 13B are side and front views of contact members with high surface area of engagement for a backplane connector in accordance with an embodiment of the present disclosure.

FIGS. 14A through 14C are side and front views of contact members for a backplane connector that capture solder balls in accordance with an embodiment of the present disclosure.

FIGS. 15A and 15B are side and front views of contact members for a backplane connector with printed electrical devices in accordance with an embodiment of the present disclosure.

FIG. 16 illustrates a substrate with recesses for making a backplane connector in accordance with a method of the present disclosure.

FIG. 17 illustrates a backplane connector made using the substrate of FIG. 16 in accordance with a method of the present disclosure.

FIG. 18 is a cross-sectional view of a backplane connector made using additive printing techniques in accordance with an embodiment of the present disclosure.

FIG. 19 is a cross-sectional view of an alternate backplane connector made using additive printing techniques in accordance with an embodiment of the present disclosure.

### DETAILED DESCRIPTION OF THE INVENTION

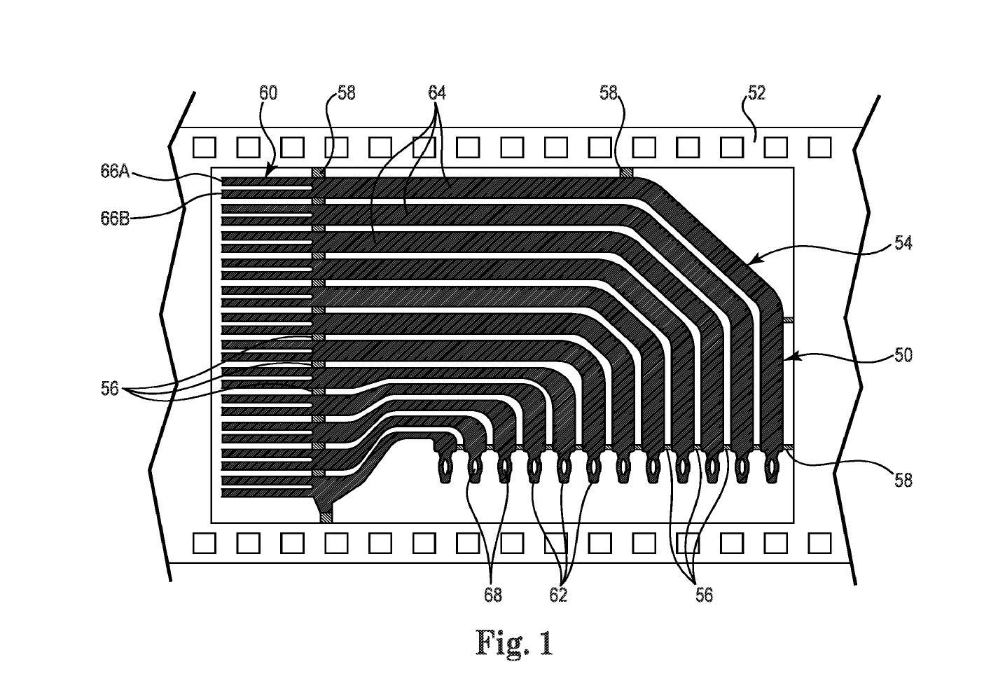

FIG. 1 illustrates a backplane connector set 50 attached to carrier 52 in accordance with an embodiment of the present disclosure. Interconnect elements 54 and tie bars 56 are created by etching or blanking as a group. The tie bars 56 retain the individual interconnect elements 54 in the desired position. Tie bars 58 retain the entire connector set 50 to the carrier 52 during the early steps of this process. The backplane connector set 50 is optionally plated.

In the illustrated embodiment, each interconnect element 54 includes contact members 60, 62 electrically coupled by conductive traces 64. The contact members 60 include a pair of beams 66A, 66B (“66”) formed during the etching or blanking process. Contact members 62 include elongated center opening 68 that permits elastic deformation during insertion into a via in a PCB. In the illustrate embodiment, the contact members 60 are oriented at a right angle relative to the contact members 62. A variety of other contact structures are discussed below.

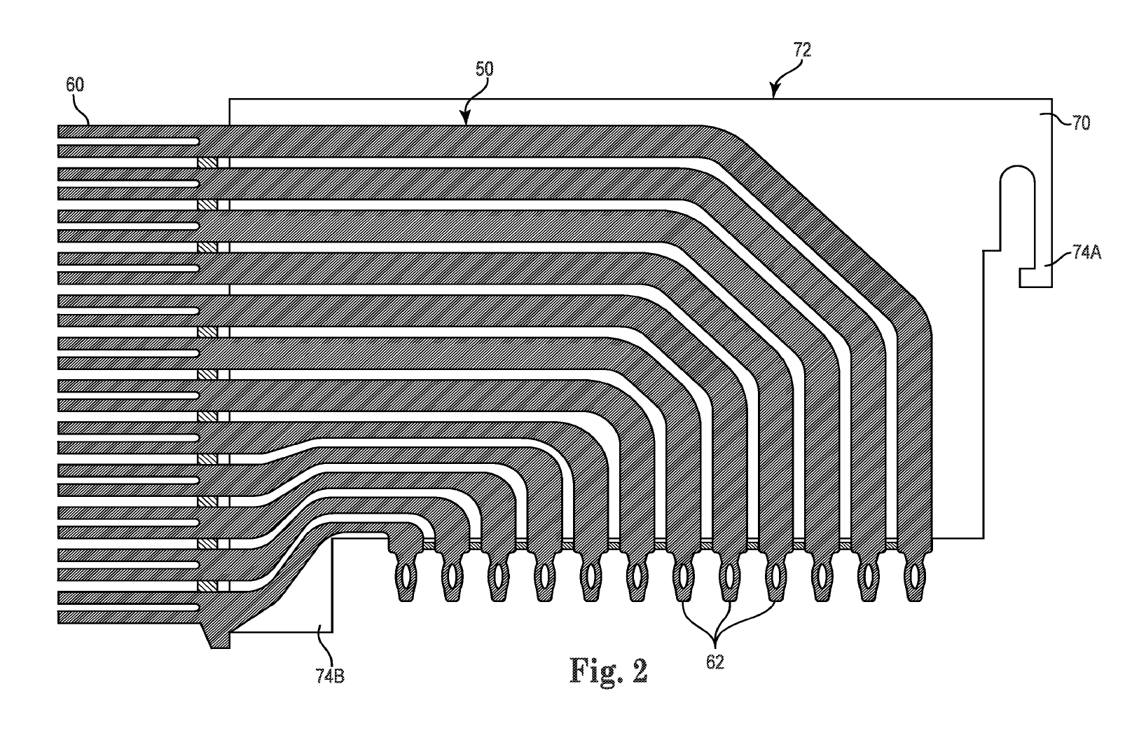

FIG. 2 illustrates the connector set 50 attached to substrate 70 in accordance with an embodiment of the present disclosure. In the illustrated embodiment, the tie bars 58 attaching the connector set 50 to the carrier 52 have been removed, but the tie bars 56 remain to support the contact members 60, 62.

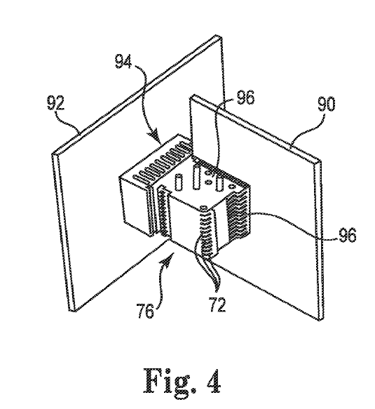

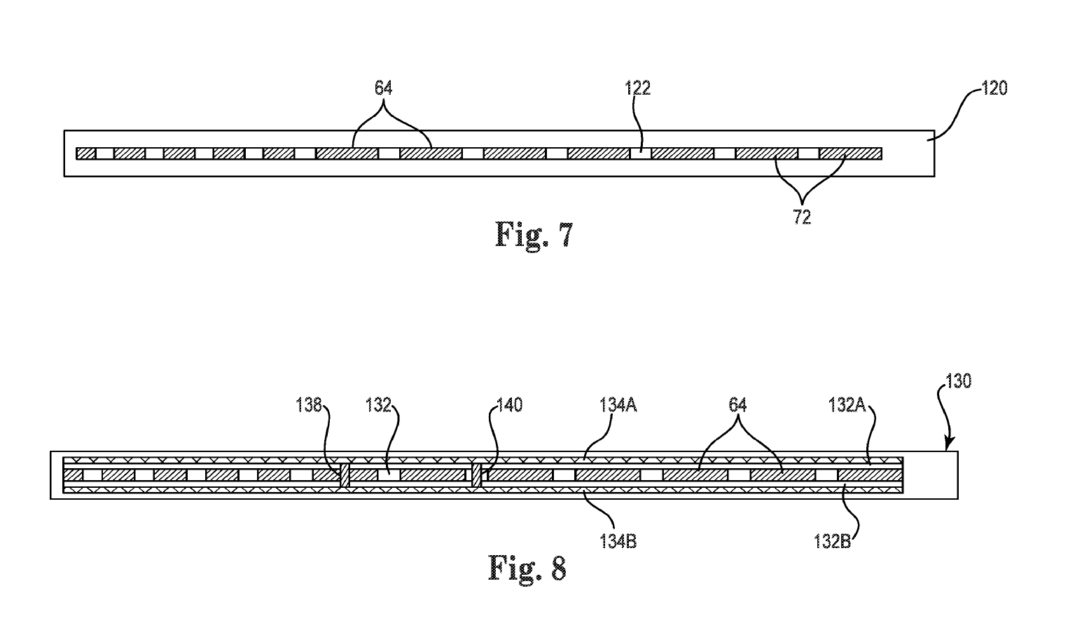

In one embodiment, the connector set 50 is placed in an overmolding or insert molding operation similar to that used in semiconductor packaging methods. See e.g., FIGS. 7 and 8. The tie bars 56, 58 are optionally blanked or etched away to eliminate the ganged structures and shorting condition. The plastic overmolding provides mechanical strength to maintain the position of the interconnect elements 54, and serves as a reference structure for locating the substrate 70 within an associated plastic housing. The overmolding also acts as a solder wicking barrier in the event the contact members 60, 62 are soldered. In one embodiment, substrate 70 includes one or more features 74A, 74B that facilitate attachment to a backplane connector assembly 76 (See FIG. 4).

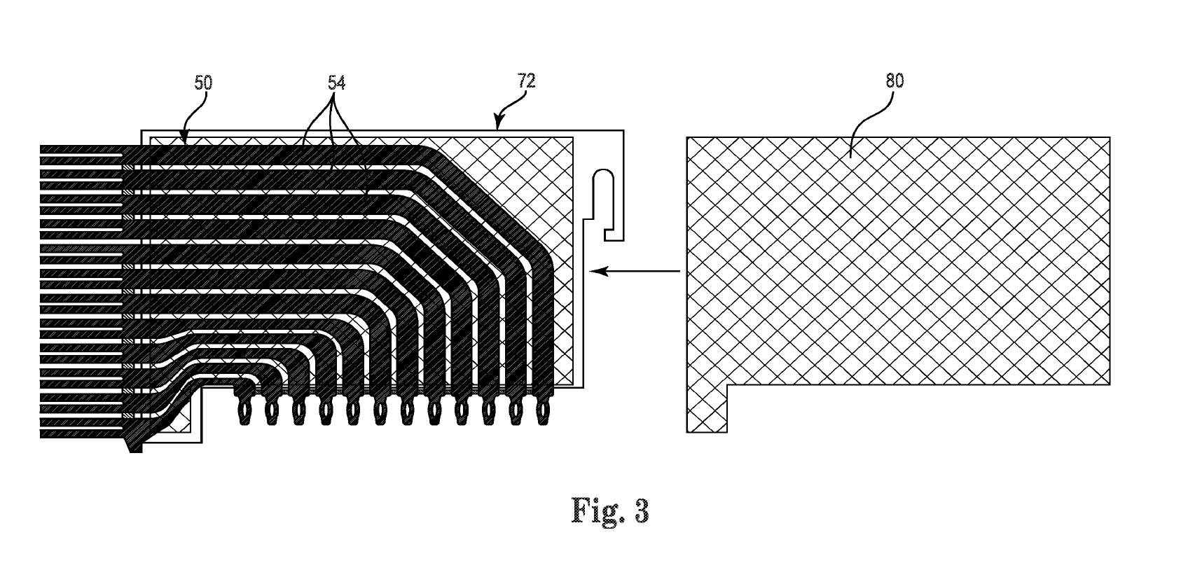

FIG. 3 illustrates an embodiment with polymeric skin 80 applied to the substrate 70 over a portion of the connector set 50. The skin 80 provides shielding, cross talk reduction, and/or ground distribution. The polymer skin 80 can also provide mechanical structure for the backplane connector 72 and prevents the overmolding material from entering the region between the interconnect elements 54, which may change impedance. Structural overmolding can be added onto the skin 80, such that reinforcement is achieved without material impinging upon the dielectric region between conductive traces 64.

FIG. 4 is a perspective view of the backplane connector assembly 76 with a plurality of backplane connectors 72 electrically coupling printed circuit boards 90, 92 in accordance with an embodiment of the present disclosure. In the illustrated embodiment, contact members 62 are inserted into vias in the PCB 90, while the contact members 60 are electrically coupled to connector 94 attached to PCB 92. The connector 94 preferably includes a plurality of sidewalls and other structures 96 that protect the individual backplane connectors 72. In one embodiment, each backplane connectors 72 is secured in a plastic housing before being engaged with the backplane connector assembly 96.

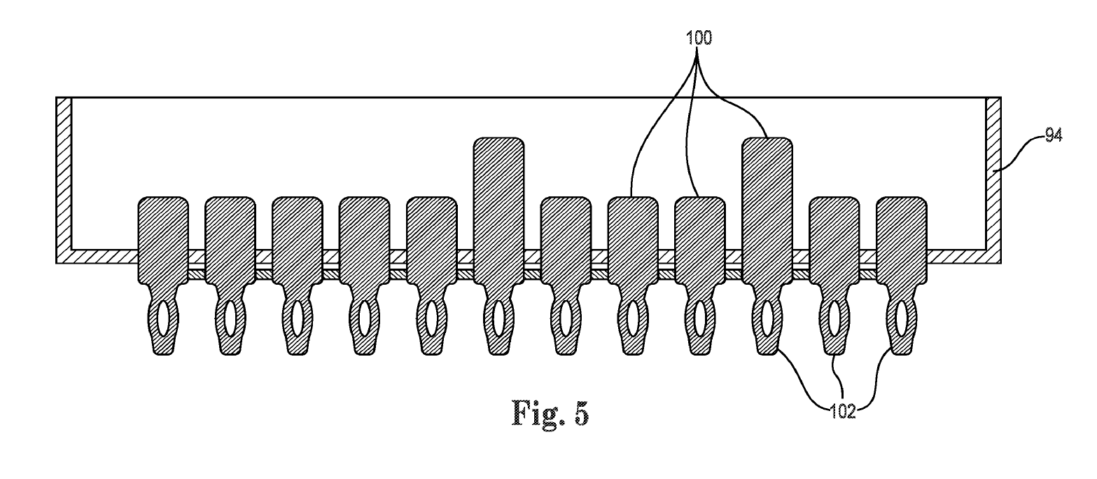

FIG. 5 is a cross-sectional view of an alternate connector 94 attached to the PCB 92 in accordance with an embodiment of the present disclosure. Blades 100 are offset to permit some of the contact members 60 to engage before others. Connector members 102 are configured to engage with vias in PCB 92.

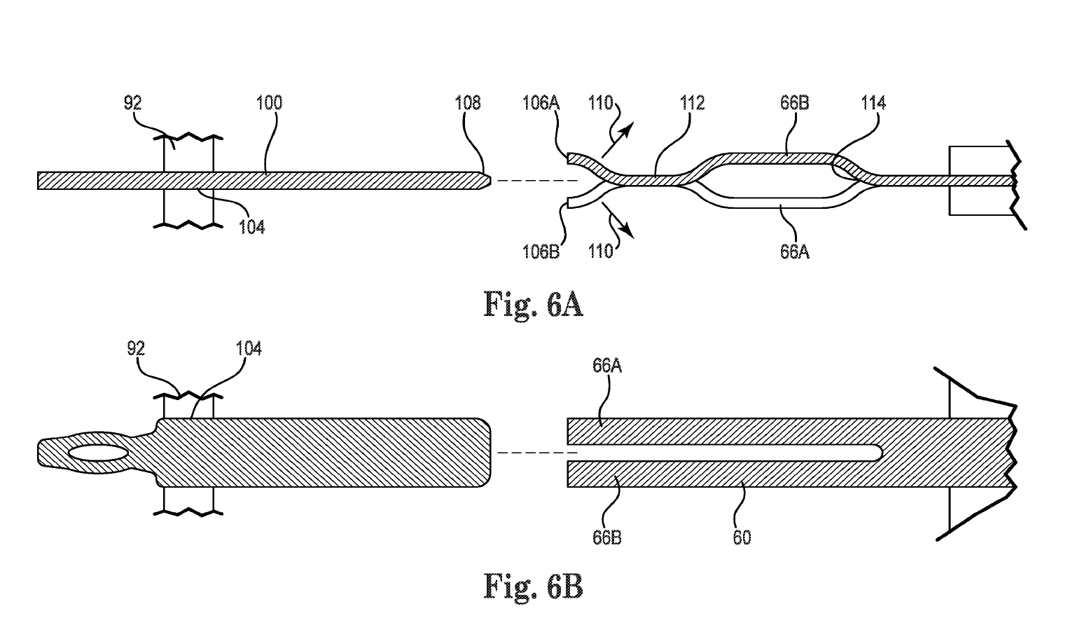

FIGS. 6A and 6B are top and side views illustrating engagement of the contact members 60 with blades 100 mounted to PCB 92 in accordance with an embodiment of the present disclosure. The blades 100 can be press-fit in vias 104 in the PCB 92, and optionally soldered in place. As illustrated in FIG. 6A, the beams 66 are configured with angled distal ends 106A, 106B (“106”) that facilitate engagement with distal end 108 of the blades 100. As the contact members 60 are advanced toward the blades 100, the distal ends 106 are displaced outward in direction 110, to permit sliding engagement with blade 100. In one embodiment, electrical coupling occurs along sections 112 and location 114 where distal end 108 engages beam 66.

FIG. 7 is a cross-sectional view of the backplane connector 72 after the application of overmolding material 120. Dielectric material 122 is preferably located between the conductive traces 64.

FIG. 8 is a cross-sectional view of an alternate backplane connector 130 in accordance with an embodiment of the present disclosure. Dielectric layers 132A, 132B (“132”) are located over the conductive traces 64. In some embodiments, the dielectric material 132 is also located between the conductive traces 64. Metalized or magnetic layers 134A, 134B (“134”) are laminated to the dielectric layers 132 to reduce cross talk or to add grounding options. The metalized or magnetic layers 134 can be a discrete material layer or doped overmold material such as used with plated plastic applications with exposed internal particles. Overmolding material 136 is optionally applied around the metalized layers 134.

In one embodiment, conductor 138 extends through one or more of the conductive traces 64 and couple with the metalized layers 134. In another embodiment, conductor 140 extends through dielectric material 132 to couple the opposing metalized layers 134A, 134B.

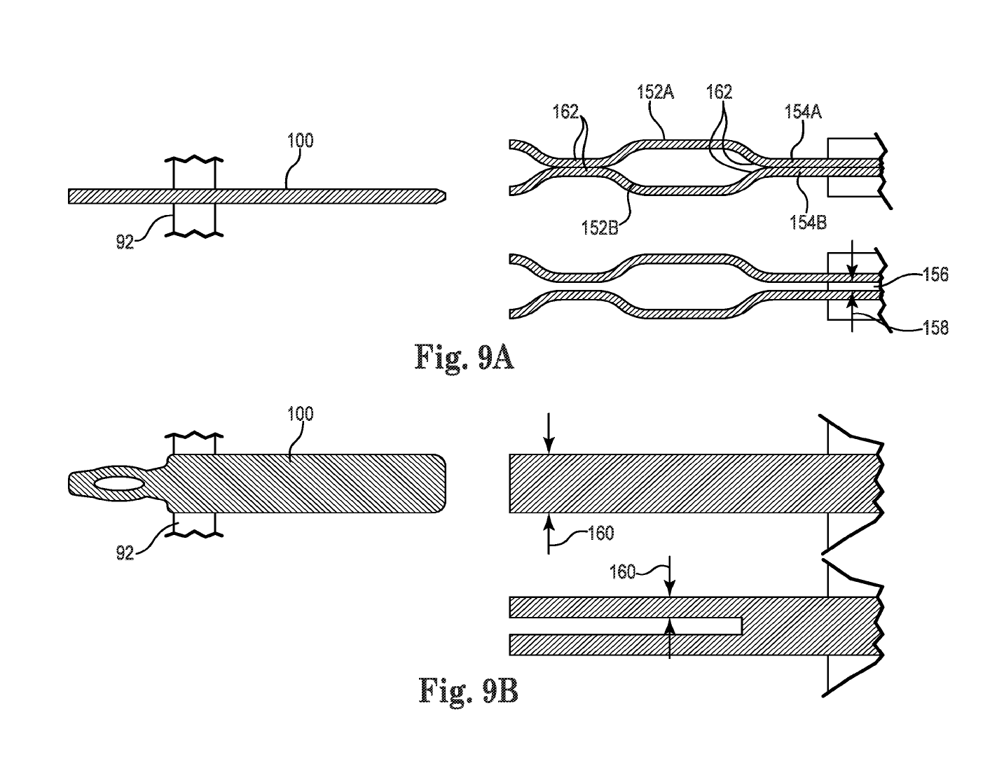

FIGS. 9A and 9B are side and top views of alternate contact members 150 adapted to couple with blades 100 on PCB 92 in accordance with an embodiment of the present disclosure. Alternate mating geometries are provided to reduce the impedance mismatch at the interconnect transition. The beams 152A, 152B (“152”) are split into two parallel planes 154A, 154B (“154”). The planes 154 are bifurcated to create a four point contact at locations 162 with the blades 100. In one embodiment, the planes 154 are separated by dielectric layer 156. The thickness 158 of the dielectric layer 156 and conductor width 160 can be modified based upon the altered environment to minimize the impedance mismatch of the channel. To increase density, the planes 154 can be structured to connect a differential pair with one plane mating with one half or the pair and the other mating with the matched pair. The metalized layer can also be extended to the contact beams to provide additional cross talk protection, or the planes can be tied to ground contacts if desired.

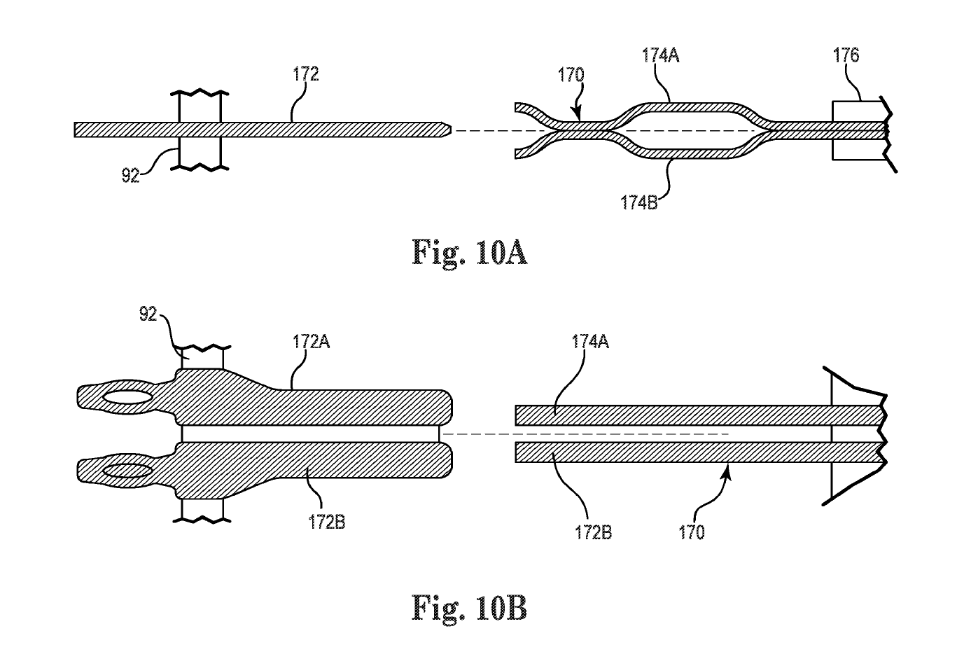

FIGS. 10A and 10B are side and top views of alternate contact members 170 on backplane connector 176 adapted to couple with bifurcated blades 172A, 172B on PCB 92 in accordance with an embodiment of the present disclosure. Beams 174A, 174B (“174”) are split to provide a mated pairs with higher density. In particular, blade 172A couples with beam 174A, and blade 172B couples with beam 174B. It may also be possible to reduce skew between the pairs 174 by more closely matching the electrical length.

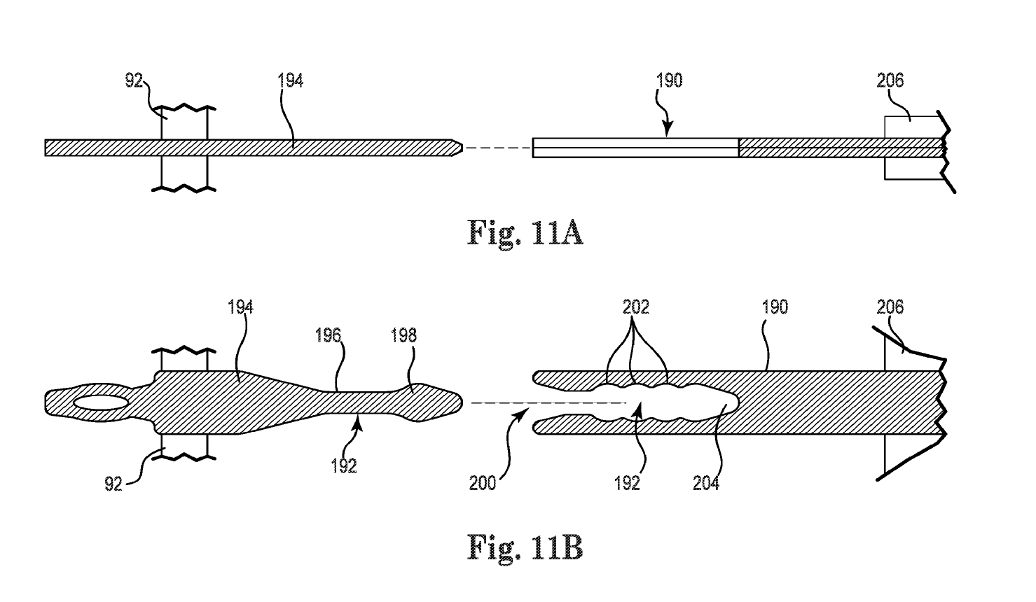

FIGS. 11A and 11B are side and top views of alternate contact members 190 with mating geometries 192 that increase the surface area of engagement in accordance with an embodiment of the present disclosure. In the illustrated embodiment, blade 194 includes a narrowed region 196 and an enlarged distal end 198. Contact members 190 on backplane connector 206 include recess 200 sized to receive the distal end 198 and a series of recesses 202 sized to engage with the enlarged distal end 198 of the blade 194. Ideally, the enlarged distal end 198 of the blade 194 is engaged with bottom 204 of recess 200. The embodiment of FIGS. 11A and 11B reduces the impact of geometry on signal integrity, and allows increased material thickness with greater aspect ratio and alternate conductor width adjustment.

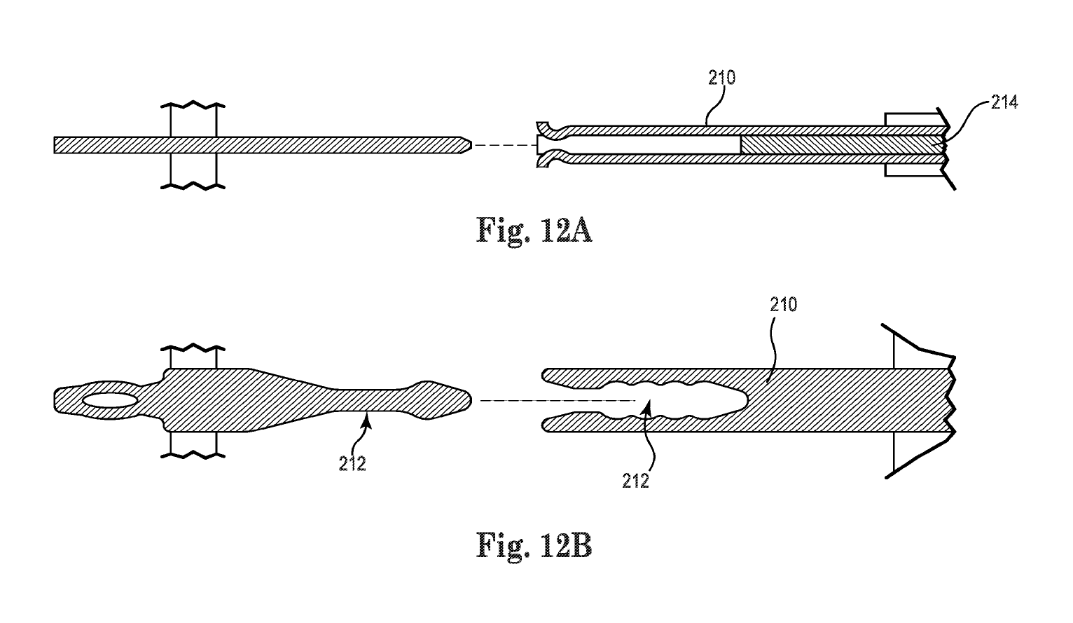

FIGS. 12A and 12B are side and top views of alternate contact members 210 with mating geometries 212 with layer 214 to enhance reliability and insertion actuation, in accordance with an embodiment of the present disclosure. The layer 214 can be conductive, dielectric, or cross-talk shielding. In one embodiment, the layer 214 is a polymeric material.

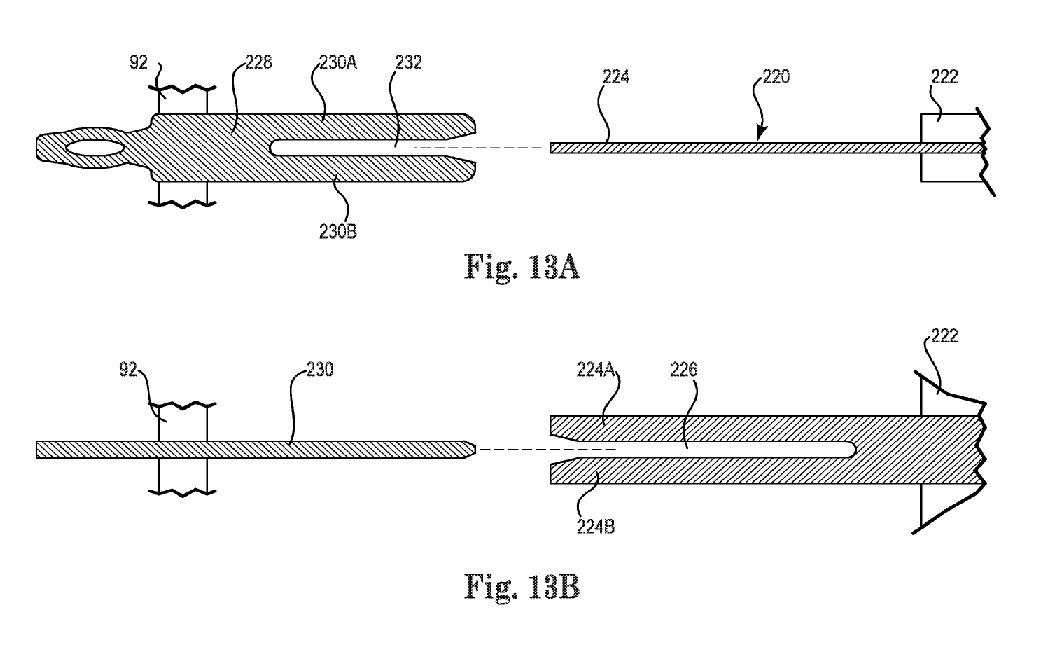

FIGS. 13A and 13B are side and top views of alternate contact members 220 that increase surface area of engagement in accordance with an embodiment of the present disclosure. The contact members 220 on the backplane connector 222 include a pair of beams 224A, 224B (“224”) separated by space 226. Blades 228 on the PCB 92 likewise include a pair of beams 230A, 230B (“230”) separated by space 232. The contact members 220 are rotated 90 degrees relative to the blades 228 to permit sliding engagement of the beams 224, 230 as the spaces 226, 232 overlap.

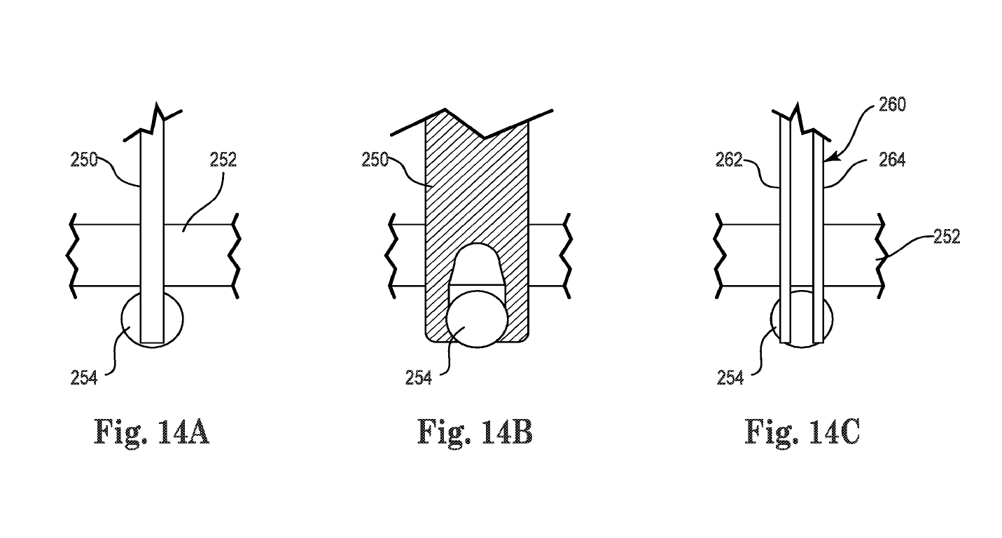

FIGS. 14A and 14B are side and front views of contact members 250 on backplane connector 252 configured to accept solder balls 254 in accordance with an embodiment of the present disclosure. Beams 256A, 256B (“256”) include opposing recesses 258 sized to accept the solder ball 254. The solder ball 254 enables surface mount attachment to the PCB 92, which eases routing and parasitic stub effects while potentially enabling increased density and shorter conductor length. FIG. 14C illustrates an alternate contact member 260 with multiple conductor layers 262, 264 that also accepts solder ball 254.

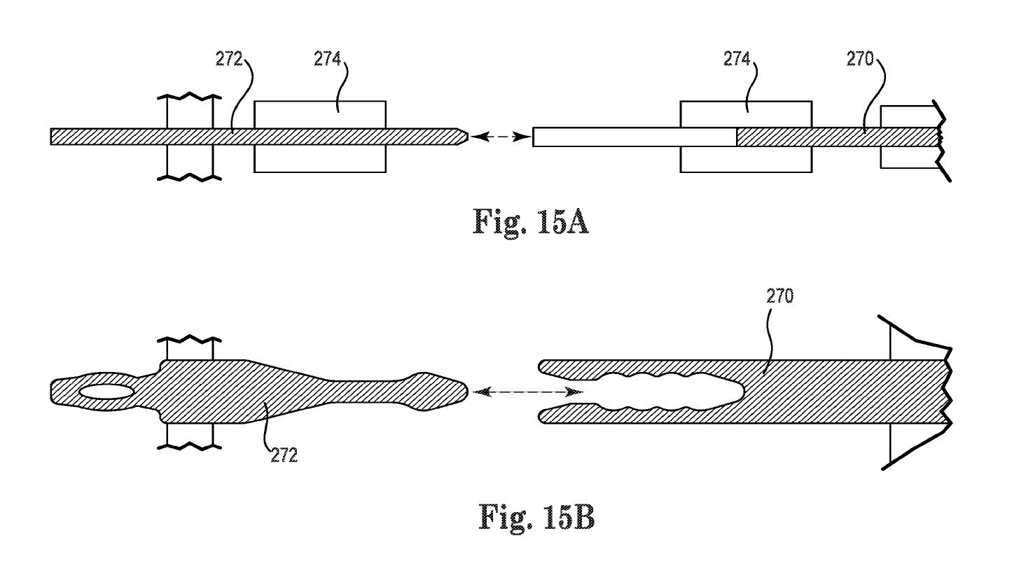

FIGS. 15A and 15B are side and top view of contact members 270 and/or blades 272 modified to correct inductance or capacitance at locations of possible mismatch in accordance with an embodiment of the present disclosure. In the preferred embodiment, an additive printing process is used to deposit a precise amount of conductive, insulative, or magnetic material 274 on the contact members 270 and/or blades 272 to increases or decreasing the inductance or capacitance.

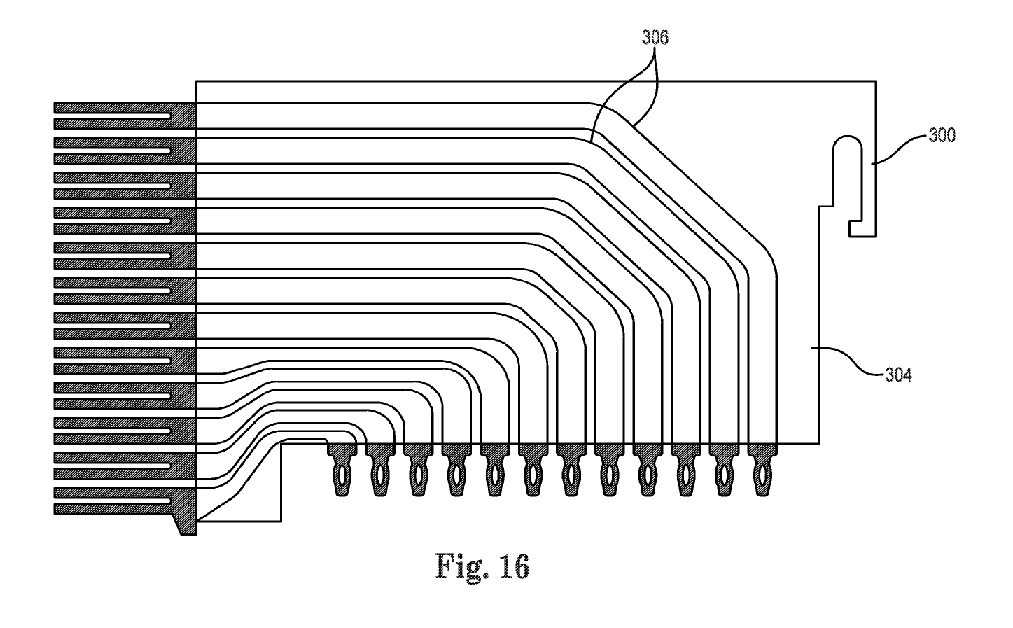

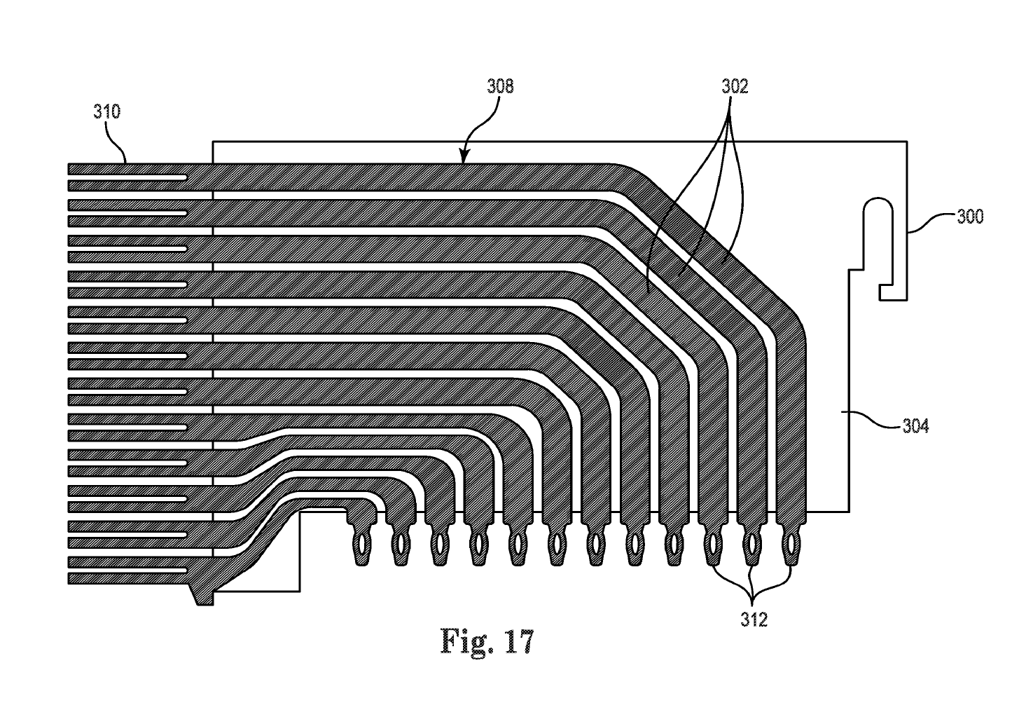

FIGS. 16 and 17 illustrate a backplane connector 300 with conductive traces 302 and dielectric materials are deposited on substrate 304 using additive printing processes in accordance with an embodiment of the present disclosure. As best illustrated in FIG. 16, channels 306 are formed on the substrate 304 by printing, embossing, imprinting, chemical etching with a printed mask, or a variety of other techniques. In one embodiment, the channels 306 are formed by selectively printing a dielectric material on substrate 304.

The substrate 304 may be constructed of any of a number of dielectric materials that are currently used to make sockets, semiconductor packaging, and printed circuit boards. Examples may include UV stabilized tetrafunctional epoxy resin systems referred to as Flame Retardant 4 (FR-4), bismaleimide-triazine thermoset epoxy resins referred to as BT-Epoxy or BT Resin, and liquid crystal polymers (LCPs), which are polyester polymers that are extremely unreactive, inert and resistant to fire. Other suitable plastics include phenolics, polyesters, and Ryton® available from Phillips Petroleum Company.

Metalizing layer is deposited in the recesses 306 to create circuit geometry 308 illustrated in FIG. 17. Metalizing can be performed by printing conductive particles followed by a sintering step, by printing conductive inks, or a variety of other techniques. The resulting metalized layer is preferably plated to improve conductive properties. The circuit geometry 308 is preferably of copper or similar metallic materials such as phosphor bronze or beryllium-copper. The plating is preferably a corrosion resistant metallic material such as nickel, gold, silver, palladium, or multiple layers thereof. A dielectric or insulating layer is optionally printed on the circuit geometry 308.

In one embodiment, the conductive traces 302 are formed by depositing a conductive material in a first state in the recesses 306, and then processed to create a second more permanent state. For example, the metallic powder is printed according to the circuit geometry 308 and subsequently sintered, or the curable conductive material flows into the circuit geometry and is subsequently cured. As used herein “cure” and inflections thereof refers to a chemical-physical transformation that allows a material to progress from a first form (e.g., flowable form) to a more permanent second form. “Curable” refers to an uncured material having the potential to be cured, such as for example by the application of a suitable energy source.

The recesses 306 permit control of the location, cross section, material content, and aspect ratio of the conductive traces 302 in the circuit geometry 308. Maintaining the conductive traces with a cross-section of 1:1 or greater provides greater signal integrity than traditional subtractive trace forming technologies. For example, traditional methods take a sheet of a given thickness and etches the material between the traces away to have a resultant trace that is usually wider than it is thick. The etching process also removes more material at the top surface of the trace than at the bottom, leaving a trace with a trapezoidal cross-sectional shape, degrading signal integrity in some applications. Using the recesses 306 to control the aspect ratio of the conductive traces results in a more rectangular or square cross-section of the conductive traces in the circuit geometry 308, with the corresponding improvement in signal integrity.

In another embodiment, pre-patterned or pre-etched thin conductive foil circuit traces are transferred to the recesses 306. For example, a pressure sensitive adhesive can be used to retain the copper foil circuit traces in the recesses 306. The trapezoidal cross-sections of the pre-formed conductive foil traces are then post-plated. The plating material fills the open spaces in the recesses 306 not occupied by the foil circuit geometry, resulting in a substantially rectangular or square cross-sectional shape corresponding to the shape of the recesses 306.

In another embodiment, a thin conductive foil is pressed into the recesses 306, and the edges of the recesses 306 acts to cut or shear the conductive foil. The process locates a portion of the conductive foil in the recesses 306, but leaves the negative pattern of the conductive foil not wanted outside and above the recesses 306 for easy removal. Again, the foil in the recesses 306 is preferably post plated to add material to increase the thickness of the conductive traces in the circuit geometry 308 and to fill any voids left between the conductive foil and the recesses 306.

The additive process can be used in combination with conventional metallic contact creation, where the mating features of the conductive channel are produced by conventional means and fused or connected to conductive channels constructed of conductive particles, plating, solder or particle loaded ink/paste. For example, the contact members 310, 312 may be made using conventional metallic contact creation approaches.

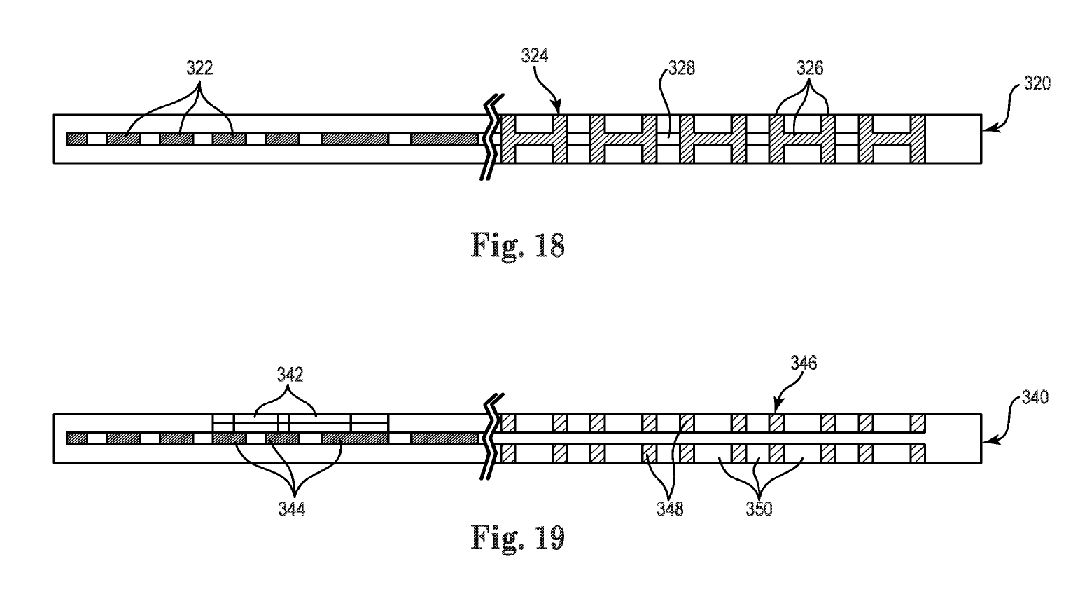

FIG. 18 is a cross sectional view of a backplane connector 320 made using the additive printing processes of the present disclosure. The contact members 322 are preferably made using conventional metallic contact creating technologies. The circuit geometry 324 is made using additive printing processes to create impedance tuned conductive traces 326 and dielectric channels 328.

FIG. 19 is a cross sectional view of an alternate backplane connector 340 made using the additive printing processes of the present disclosure. Passive or active electrical devices 342 are printed on the backplane connector 340 and electrically coupled to contact members 344. Again, circuit geometry 346 is made using additive printing processes to create impedance tuned conductive traces 348 and dielectric channels 350.

The electrical devices 342 are preferably printed during construction of the backplane connector 340. The electrical devices 342 can be ground planes, power planes, electrical connections to other circuit members, dielectric layers, conductive traces, transistors, capacitors, resistors, RF antennae, shielding, filters, signal or power altering and enhancing devices, memory devices, embedded IC, and the like. For example, the electrical devices 342 can be formed using printing technology, adding intelligence to the backplane connector 340. Features that are typically located on other circuit members can be incorporated into the backplane connector 340 in accordance with an embodiment of the present disclosure.

A solder ball can be added or solder can be printed onto the circuit geometry 346, which provides the wetting surface and inherently prevents solder wicking during reflow. The circuit geometry 346 can serve as a base for adding circuitry, such as redistributing or reducing the pitch between the backplane connector 340 and the PCB's 90, 92. Internal decoupling capacitance can be printed on the backplane connector 340. Embedded passive enhancements can be added as discrete components or printed materials which result in the desired effect, potentially reducing the need for discrete components.

The availability of printable silicon inks provides the ability to print electrical devices 342, such as disclosed in U.S. Pat. Nos. 7,485,345 (Renn et al.); 7,382,363 (Albert et al.); 7,148,128 (Jacobson); 6,967,640 (Albert et al.); 6,825,829 (Albert et al.); 6,750,473 (Amundson et al.); 6,652,075 (Jacobson); 6,639,578 (Comiskey et al.); 6,545,291 (Amundson et al.); 6,521,489 (Duthaler et al.); 6,459,418 (Comiskey et al.); 6,422,687 (Jacobson); 6,413,790 (Duthaler et al.); 6,312,971 (Amundson et al.); 6,252,564 (Albert et al.); 6,177,921 (Comiskey et al.); 6,120,588 (Jacobson); 6,118,426 (Albert et al.); and U.S. Pat. Publication No. 2008/0008822 (Kowalski et al.), which are hereby incorporated by reference. In particular, U.S. Pat. Nos. 6,506,438 (Duthaler et al.) and 6,750,473 (Amundson et al.), which are incorporated by reference, teach using ink-jet printing to make various electrical devices, such as, resistors, capacitors, diodes, inductors (or elements which may be used in radio applications or magnetic or electric field transmission of power or data), semiconductor logic elements, electro-optical elements, transistor (including, light emitting, light sensing or solar cell elements, field effect transistor, top gate structures), and the like.

The electrical devices 342 can also be created by aerosol printing, such as disclosed in U.S. Pat. Nos. 7,674,671 (Renn et al.); 7,658,163 (Renn et al.); 7,485,345 (Renn et al.); 7,045,015 (Renn et al.); and 6,823,124 (Renn et al.), which are hereby incorporated by reference.

Printing processes are preferably used to fabricate various functional structures, such as conductive paths and electrical devices, without the use of masks or resists. Features down to about 10 microns can be directly written in a wide variety of functional inks, including metals, ceramics, polymers and adhesives, on virtually any substrate—silicon, glass, polymers, metals and ceramics. The substrates can be planar and non-planar surfaces. The printing process is typically followed by a thermal treatment, such as in a furnace or with a laser, to achieve dense functionalized structures.

Ink jet printing of electronically active inks can be done on a large class of substrates, without the requirements of standard vacuum processing or etching. The inks may incorporate mechanical, electrical or other properties, such as, conducting, insulating, resistive, magnetic, semi conductive, light modulating, piezoelectric, spin, optoelectronic, thermoelectric or radio frequency.

A plurality of ink drops are dispensed from the print head directly to a substrate or on an intermediate transfer member. The transfer member can be a planar or non-planar structure, such as a drum. The surface of the transfer member can be coated with a non-sticking layer, such as silicone, silicone rubber, or Teflon.

The ink (also referred to as function inks) can include conductive materials, semi-conductive materials (e.g., p-type and n-type semiconducting materials), metallic material, insulating materials, and/or release materials. The ink pattern can be deposited in precise locations on a substrate to create fine lines having a width smaller than 10 microns, with precisely controlled spaces between the lines. For example, the ink drops form an ink pattern corresponding to portions of a transistor, such as a source electrode, a drain electrode, a dielectric layer, a semiconductor layer, or a gate electrode.

The substrate can be an insulating polymer, such as polyethylene terephthalate (PET), polyester, polyethersulphone (PES), polyimide film (e.g. Kapton, available from DuPont located in Wilmington, Del.; Upilex available from Ube Corporation located in Japan), or polycarbonate. Alternatively, the substrate can be made of an insulator such as undoped silicon, glass, or a plastic material. The substrate can also be patterned to serve as an electrode. The substrate can further be a metal foil insulated from the gate electrode by a non-conducting material. The substrate can also be a woven material or paper, planarized or otherwise modified on at least one surface by a polymeric or other coating to accept the other structures.

Electrodes can be printed with metals, such as aluminum or gold, or conductive polymers, such as polythiophene or polyaniline. The electrodes may also include a printed conductor, such as a polymer film comprising metal particles, such as silver or nickel, a printed conductor comprising a polymer film containing graphite or some other conductive carbon material, or a conductive oxide such as tin oxide or indium tin oxide.

Dielectric layers can be printed with a silicon dioxide layer, an insulating polymer, such as polyimide and its derivatives, poly-vinyl phenol, polymethylmethacrylate, polyvinyldenedifluoride, an inorganic oxide, such as metal oxide, an inorganic nitride such as silicon nitride, or an inorganic/organic composite material such as an organic-substituted silicon oxide, or a sol-gel organosilicon glass. Dielectric layers can also include a bicylcobutene derivative (BCB) available from Dow Chemical (Midland, Mich.), spin-on glass, or dispersions of dielectric colloid materials in a binder or solvent.

Semiconductor layers can be printed with polymeric semiconductors, such as, polythiophene, poly(3-alkyl)thiophenes, alkyl-substituted oligothiophene, polythienylenevinylene, poly(para-phenylenevinylene) and doped versions of these polymers. An example of suitable oligomeric semiconductor is alpha-hexathienylene. Horowitz, Organic Field-Effect Transistors, Adv. Mater., 10, No. 5, p. 365 (1998) describes the use of unsubstituted and alkyl-substituted oligothiophenes in transistors. A field effect transistor made with regioregular poly(3-hexylthiophene) as the semiconductor layer is described in Bao et al., Soluble and Processable Regioregular Poly(3-hexylthiophene) for Thin Film Field-Effect Transistor Applications with High Mobility, Appl. Phys. Lett. 69 (26), p. 4108 (December 1996). A field effect transistor made with a-hexathienylene is described in U.S. Pat. No. 5,659,181, which is incorporated herein by reference.

A protective layer can optionally be printed onto the electrical devices. The protective layer can be an aluminum film, a metal oxide coating, a polymeric film, or a combination thereof.

Organic semiconductors can be printed using suitable carbon-based compounds, such as, pentacene, phthalocyanine, benzodithiophene, buckminsterfullerene or other fullerene derivatives, tetracyanonaphthoquinone, and tetrakisimethylanimoethylene. The materials provided above for forming the substrate, the dielectric layer, the electrodes, or the semiconductor layer are exemplary only. Other suitable materials known to those skilled in the art having properties similar to those described above can be used in accordance with the present disclosure.

The ink-jet print head preferably includes a plurality of orifices for dispensing one or more fluids onto a desired media, such as for example, a conducting fluid solution, a semiconducting fluid solution, an insulating fluid solution, and a precursor material to facilitate subsequent deposition. The precursor material can be surface active agents, such as octadecyltrichlorosilane (OTS).

Alternatively, a separate print head is used for each fluid solution. The print head nozzles can be held at different potentials to aid in atomization and imparting a charge to the droplets, such as disclosed in U.S. Pat. No. 7,148,128 (Jacobson), which is hereby incorporated by reference. Alternate print heads are disclosed in U.S. Pat. No. 6,626,526 (Ueki et al.), and U.S. Pat. Publication Nos. 2006/0044357 (Andersen et al.) and 2009/0061089 (King et al.), which are hereby incorporated by reference.

The print head preferably uses a pulse-on-demand method, and can employ one of the following methods to dispense the ink drops: piezoelectric, magnetostrictive, electromechanical, electro pneumatic, electrostatic, rapid ink heating, magneto hydrodynamic, or any other technique well known to those skilled in the art. The deposited ink patterns typically undergo a curing step or another processing step before subsequent layers are applied.

While ink jet printing is preferred, the term “printing” is intended to include all forms of printing and coating, including: pre-metered coating such as patch die coating, slot or extrusion coating, slide or cascade coating, and curtain coating; roll coating such as knife over roll coating, forward and reverse roll coating; gravure coating; dip coating; spray coating; meniscus coating; spin coating; brush coating; air knife coating; screen printing processes; electrostatic printing processes; thermal printing processes; and other similar techniques.

The present disclosure has several advantages over conventional technologies. The methods described provide a process to handle the contacts and conductive members as a group, as well as enable the potential to improve the impedance mismatch as signals propagate. The present structures allow for potential pitch reduction and density improvement over conventional products. The ability to remove complaint tail termination and to add solder ball reflow attachments reduces the parasitic effects of compliant tail in via connections, while relieving routing constraints.

The additive printing process provides a significant opportunity to enhance the electrical performance of the backplane connector, while enabling the conductor assembly or module to be treated as if it were a printed circuit assembly or semiconductor package substrate. Selective addition of conductive, insulative, non-conductive, or magnetic materials can be designed such that characteristic impedance profiles are tuned to more closely match the system budget. Embedded function can be added to the structure, such as, shielding, grounding, transistors, power or thermal management, filters, amplifiers, RF Antennae, memory, capacitive coupling, decoupling etc.

The present methods are compatible with existing high volume manufacturing techniques. The layered structures provide the opportunity to add stiffening features to reduce the effects of heat induced warpage during solder reflow. The overall cost and complexity of the system PCB is reduced by adding functions to the backplane connector. Solder joint reliability is increased by adding mechanical decoupling or features that improve the shear strength of the joint. The additive printing process permits reduced or redistributed terminal pitch, without the addition of an interposer or daughter substrate. Grounding schemes can be added within the connector that may reduce the number of connections to the PCB and relieves routing constraints while increasing performance. Shielding can be added to regions throughout the backplane connector to reduce the effects of cross talk. Power delivery and power management layers can be added to the backplane connector to reduce the load on the PCB. Electronic devices can be added or printed on the backplane connector.

Where a range of values is provided, it is understood that each intervening value, to the tenth of the unit of the lower limit unless the context clearly dictates otherwise, between the upper and lower limit of that range and any other stated or intervening value in that stated range is encompassed within the embodiments of the disclosure. The upper and lower limits of these smaller ranges which may independently be included in the smaller ranges is also encompassed within the embodiments of the disclosure, subject to any specifically excluded limit in the stated range. Where the stated range includes one or both of the limits, ranges excluding either both of those included limits are also included in the embodiments of the present disclosure.

Unless defined otherwise, all technical and scientific terms used herein have the same meaning as commonly understood by one of ordinary skill in the art to which the embodiments of the present disclosure belong. Although any methods and materials similar or equivalent to those described herein can also be used in the practice or testing of the embodiments of the present disclosure, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present disclosure is not entitled to antedate such publication by virtue of prior invention. Further, the dates of publication provided may be different from the actual publication dates which may need to be independently confirmed.

Other embodiments of the disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of the present disclosure. It should be understood that various features and aspects of the disclosed embodiments can be combined with or substituted for one another in order to form varying modes of the disclosed embodiments of the disclosure. Thus, it is intended that the scope of the present disclosure herein disclosed should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment(s) that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

What is claimed is:

1. A backplane connector comprising:
a substrate; and
a backplane connector set attached to the substrate, the backplane connector set comprising a plurality of interconnect elements each having a conductive trace, a first contact member; and a second contact members matched to the first contact member, the first and second contact members extending beyond perimeter edges of the substrate, and a plurality of conductive tie bars retaining the interconnect elements in a fixed relationship prior to attachment to the substrate.

2. The backplane connector of claim 1 wherein a plurality of the first contact members comprises bifurcated beams.

3. The backplane connector of claim 2 wherein each beam comprises a separate circuit path.

4. The backplane connector of claim 1 wherein a plurality of the first contact members comprise a plurality of conductive layers.

5. The backplane connector of claim 4 wherein the plurality of conductive layers are separated by a dielectric layer.

6. The backplane connector of claim 1 comprising:
a pair of opposing surfaces at distal ends of a plurality of the first contact members; and
solder balls captured between the opposing surfaces.

7. The backplane connector of claim 1 comprising one or more of a dielectric layer and a shielding layer laminated to at least the conductive traces.

8. The backplane connector of claim 1 comprising at least one electrical device printed on the substrate and electrically coupled to at least one conductive trace.

9. A backplane connector assembly comprising:
the backplane connector of claim 1;
a first printed circuit board electrically coupled to the first contact members; and
a second printed circuit board electrically coupled to the second contact members.

10. The backplane connector assembly of claim 9 wherein the first contact members extend into vias in the first printed circuit board.

11. The backplane connector assembly of claim 9 wherein the second contact members are electrically coupled with blades on an intermediate connector attached to the second printed circuit board.

12. The backplane connector comprising:
a plurality of recesses in the substrate corresponding to a circuit geometry;
a conductive material deposited in at least a portion of the recesses comprising conductive traces;
a first contact member and a second contact members matched to the first contact member electrically coupled to each conductive trace, the first and second contact members extending beyond perimeter edges of the substrate; and
at least one dielectric covering layer extending over at least the conductive traces.

13. The backplane connector of claim 12 wherein the conductive material comprises one of sintered conductive particles or a conductive ink.

14. The backplane connector of claim 12 comprising at least one printed electrical device electrically coupled to at least a portion of the circuit geometry.

15. The backplane connector of claim 12 wherein the first and second contact members are preformed before being electrically coupled to the circuit traces.

16. The backplane connector of claim 12 wherein conductive traces in the circuit geometry comprise substantially rectangular cross-sectional shapes.

17. A method of making a backplane connector comprising the step of:
forming a backplane connector set comprising a plurality of interconnect elements each having a conductive trace, a first contact member; and a second contact member matched to the first contact member, and a plurality of conductive tie bars retaining the interconnect elements in a fixed relationship prior to attachment to the substrate;
attaching the backplane connector set to a substrate so that the first and second contact members extending beyond perimeter edges of the substrate; and
removing the tie bars.

18. The method of claim 17 comprising the steps of:
forming the first contact members as bifurcated beams; and
displacing the bifurcated beams outward during engagement with blade contacts on a printed circuit board.

19. The method of claim 18 wherein each beam comprises a separate circuit path.

20. The method of claim 17 comprising forming the first contact members as a multi-layered structure.

21. The method of claim 17 comprising capturing a solder ball between a pair of opposing surfaces at distal ends of the first contact members.

22. The method of claim 17 comprising printing at least one electrical device electrically coupled to at least one conductive trace.

23. A method of making a backplane connector comprising the steps of:
forming a plurality of recesses in a substrate corresponding to target conductive traces;
printing a conductive material in at least a portion of the recesses comprising a conductive traces;
attaching matched pairs of first and second contact members to each conductive trace such that the first and second contact members extend beyond perimeter edges of the substrate; and
printing at least one dielectric covering layer over at least the conductive traces.
